(19) United States
(12) Patent Application Publication
(10) Pub. No.: US 2012/0260819 A1
(43) Pub. Date: Oct. 18, 2012

(54) THERMAL REFLECTIVE PAINT

(76) Inventor: Amit Ashok Ganpule, Gujrat (IN)

(21) Appl. No.: 13/320,342

(22) PCT Filed: May 11, 2010
(86) PCT No.: PCT/IN10/00303

§ 371 Date: Jul. 2, 2012

(30) Foreign Application Priority Data
May 11, 2009 (IN) 292/MUM/2009

(51) Int. Cl. C09D 5/33; C08K 3/22; C09D 5/14

(52) U.S. Cl. 106/15.05; 106/286.5; 106/286.2; 106/287.17; 524/437; 523/219; 523/122

(57) ABSTRACT

Thermal reflective paint comprising of active heat reflective agent in the percentage 5% to 100%, bulk forming agents or fillers in the percentage 5% 95% alongwith binders and additives

### FIELD OF THE INVENTION

Present invention relates to a thermal reflective paint. More particularly, present invention relates to a thermal reflective paint for all types of roofs.

### PRIOR ART

The global warming is a reality now. The temperatures are rising all over the world. The urban heat island effect is faced by all urban areas. On this background present invention is for minimizing the effects of both the global warming and heat island effect. Present invention will provide an effective and cheap solution as a heat reflective coating. There are few existing products, which are made using active ingredient such as ceramic materials available and titaniun Oxide or Zirconium compounds.

### DIS-ADVANTAGES OF THE PRIOR ART

1. These materials are difficult to manufacture.

2. The application of product made out of the mentioned material requires specialized skills.

### STATEMENT OF THE INVENTION

According to this invention therefore, a thermal reflective paint comprising of active heat reflective agent in the percentage 5% to 100%, bulk forming agents or fillers in the percentage 5% 95% alongwith binders and additives. Further the active heat reflective agent can be calcined aumina and hydrated Alumina in isolation or in combination thereof.

### BRIEF DESCRIPTION OF THE INVENTION

Thermal reflective paint as per the present invention comprising of active heat reflective agent in the percentage 5% to 100%, bulk forming agents or fillers in the percentage 5% 95% alongwith binders and additives. The said thermal reflective paint can be used as per optional carrier suitable as per the application. The thermal reflective paint as per the present invention comprises of the active heat reflective agents such as calcined aumina and/or hydrated Alumina in isolation or in combination thereof.

In the said thermal reflective paint the bulk forming agents or fillers can be selected from talc, mica, clay, dolomite, marble, natural stone, magnesium bearing minerals, silicon bearing minerals, metal and metal oxides, titanium oxide and ceramic and glass hollow spheres, naturally occurring hollow spheres separated from fly ash and volcanic ash in isolation or in combination. The binders of the thermal reflective paint can include but not limited to acrylic, vinyl acrylic (polyvinyl acetate), or styreneated acrylic base or naturally occurring and manmade gums, resins, and silicon based polymeric binders. Thermal reflective paint can have additives as rheology modifying agents and biocides.

The thermal reflective paint as per the present invention can be described with reference to examples which are illustrative of the invention and can not be considered as limitation of the present invention.

### Example 1

A heat reflective pigment consisting of a mixture of calcined aumina (Aluminium Oxide) 0 to 20% and Talc consisting of 100% to 80% by weight with or without carrier as per the application.

### Example 2

A heat reflective pigment consisting of a mixture of Hydrated Aluminum Oxide (Aluminium Oxide trihydrate) 0 to 20% and Talc consisting of 100 to 80% by weight alongwith the colouring agents.

### Example 3

A heat reflective pigment consisting of a mixture calcined aumina 10% and hydrated Alumina in 10% and marble powder consisting of 80% by weight alongwith the colouring agents

### Example 4

A heat reflective pigment consisting of a mixture of calcined aumina (Aluminium Oxide) 20% to 50% and dolomite consisting of 80% to 50% by weight alongwith the binders, colouring agents and additives.

### Examples 5

A heat reflective pigment consisting of a mixture of Hydrated Aluminum Oxide (Aluminium Oxide trihydrate) 20% to 50% and mica powder, talc, dolomite, titanium oxide and ceramic and glass hollow spheres, naturally occurring hollow spheres separated from fly ash and volcanic ash in combination in 80% to 50% by weight alongwith binders and colouring agents.

### Example 6

A heat reflective pigment consisting of a mixture of calcined aumina (Aluminium Oxide) 50 to 80% and talc, mica, clay, dolomite, marble, natural stone, magnesium bearing minerals, silicon bearing minerals, metal and metal oxides, titanium oxide and ceramic and glass hollow spheres, naturally occurring hollow spheres separated from fly ash and volcanic ash in isolation or in combination in 50% to 20% by weight.

### Example 7

A heat reflective pigment consisting of a mixture of calcined aumina 10% and hydrated Alumina in 10% and talc, mica, clay, dolomite, marble, natural stone, magnesium bearing minerals, silicon bearing minerals, metal and metal oxides, titanium oxide and ceramic and glass hollow spheres, naturally occurring hollow spheres separated from fly ash and volcanic ash in isolation or in combination in 80% by weight.

### Example 8

A heat reflective pigment consisting of a mixture of calcined aumina (Aluminium Oxide) 80 to 100% and Talc consisting of 20 to 0% by weight with or without carrier and colouring agents.

### ANALYTICAL DATA

1. The thermal reflective paint as per the present invention lowers the surface temperature where the paint is applied and exposed to sunlight by about 15 Deg. C. as compared to grey cement surface in hot tropical areas in summer.

2. Solar reflective index of normal paints and coatings is below 78, however solar reflective index of the thermal reflective paint as per the present invention is above 78 and in most of the cases as described in the examples above the solar reflective index is above 85.

### APPLICATION OF THE INVENTION

The paint as per the present invention is suitable for all types of roofs. Internal and external walls, pavements and walk ways, coverings and awnings, automobile roofs and all places and articles exposed to radiated heat.

### ADVANTAGES OF THE INVENTION

1. Easy applicability.

2. Lower cost

3. Use of minimal processed materials.

4. Lower use of energy for cooling.

5. Environment friendly.

1-7. (canceled)

8. A thermal reflective paint comprising:
at least one active heat reflective agent, present in the range of about 5 wt % to about 100 wt %;
at least one bulk forming agents or filler, present in the range of about 5 wt % to about 95%; and
optionally a binder, rheology modifying additive, biocide, coloring agent, or combination thereof.

9. The thermal reflective paint of claim 8, further comprising a carrier.

10. The thermal reflective paint of claim 8, wherein the at least one active heat reflective agent comprises calcined alumina or hydrated alumina.

11. The thermal reflective paint of claim 8, wherein the at least one active heat reflective agent consists of calcined alumina or hydrated alumina.

12. The thermal reflective paint of claim 8, wherein the bulk forming agent or filler is natural stone, magnesium bearing minerals, silicon bearing minerals, metal and metal oxides, ceramic and glass hollow spheres, naturally occurring hollow spheres separated from fly ash and volcanic ash, or a combination thereof.

13. The thermal reflective paint of claim 8, wherein, the bulk forming agent or filler is talc, mica, clay, dolomite, marble, or titanium oxide.

14. A thermal reflective paint comprising:
at least one active heat reflective agent, present at a concentration of less than 20 wt %;
at least one bulk forming agents or filler, present in the range of about 80 wt % to about 100 wt %; and
optionally a binder, carrier, rheology modifying additive, biocide, coloring agent, or combination thereof.

15. The thermal reflective paint of claim 14 wherein the at least one active heat reflecting agent consists of calcined alumina, hydrated alumina, or a mixture thereof.

16. The thermal reflective paint of any one of claims 8-15, wherein the solar reflective index is greater than 78.
